(19) United States
(12) Patent Application Publication
(10) Pub. No.: US 2014/0188549 A1
(43) Pub. Date: Jul. 3, 2014

(54) RISK ASSESSMENT METHOD AND SYSTEM FOR THE SECURITY OF AN INDUSTRIAL INSTALLATION

(71) Applicant: ENI S.p.A., Roma (IT)

(72) Inventor: Umberto SACCONE, Sacrofano (IT)

(73) Assignee: ENI S.p.A., Roma (IT)

(21) Appl. No.: 14/140,156

(22) Filed: Dec. 24, 2013

(30) Foreign Application Priority Data
Dec. 28, 2012 (IT) MI2012A 002255

(51) Int. Cl. G06Q 10/06

(52) U.S. Cl. CPC G06Q 10/0635
USPC 705/7.28

(57) ABSTRACT

The present invention relates to a risk assessment method and system for the security of an industrial installation of at least one company, wherein the method comprises the following phases: analyzing a first plurality of data for determining an index of potential threats to the security of the industrial installation; analyzing a second plurality of data for determining a vulnerability index for the security of the industrial installation; identifying a security risk value on the basis of the indexes of potential threats and vulnerability determined; the risk assessment method is characterized in that the phase of analyzing the first plurality of data comprises the following phases: receiving at least one piece of information in the form of textual data from at least one information storage unit; effecting a correspondence analysis between the textual data and a plurality of data included in a master database of the at least one company; assigning a first relevance value to the at least one piece of information according to the result of the correspondence analysis.

The present invention relates to a risk assessment method and system for the security of an industrial installation.

Currently, it is known to assess and monitor the security of installations and industrial activities of a company through periodic empirical observations and analysis of potential threats to security and vulnerabilities of the related industrial equipment and installations.

In particular, the security manager of an industrial installation is generally responsible for a significant amount of information, such as related to current news available on a number of newspapers considered as reliable, as well as specialized documentation, and for assessing the probability that threats to the security of the industrial installation under its responsibility may arise.

For each possible threat, the security manager determines an index that represents the seriousness of the threat itself.

At the same time, such a security manager usually monitors and controls the vulnerabilities which the industrial installation may undergo, as well as assesses whether there are new vulnerabilities that may arise as a result, for example, of a change in the security procedures or a change to the external alarm system and so on.

In order to carry out such monitoring and assessment, it is known to periodically distribute questionnaires about security to a plurality of individuals, such as area or line managers, which provide to filling in such questionnaires on the basis of empirical observations and experience.

Known questionnaires generally differ depending on the type of industrial installation to which they refer and include both open-ended questions and closed-ended questions.

Based on the answers given to the questions of such questionnaires, the security manager determines a vulnerability index for the security of the industrial installation.

Then, it is known to determine a security risk value on the basis of the indexes of potential threats and vulnerabilities of the industrial installation.

The risk assessment procedure described so far, however, has some drawbacks mainly due to the lack of reliability of any empirical observation method.

In fact, the determination of the indexes of potential threats and vulnerabilities is not the result of a systematic and automatic procedure but depends on the judgment of the individual responsible for security and therefore on his/her observation and experience.

The analysis of potential threats also requires the analysis of a massive amount of information that is neither classified nor sorted, for example based on the subject it refers to. Such an analysis, of course, requires much time and therefore, it is not always possible to identify threats to the security of an industrial installation in a timely and effective manner.

In addition, the analysis of vulnerabilities in the industrial installation is based on the analysis of a number of questionnaires that are not filled in in a systematic manner by the responsible individuals, who base their answers on experience and sensitivity which vary from person to person.

The vulnerability assessment, therefore, is always affected by a certain degree of subjectivity that can affect the final judgment about the security risk.

The object of the present invention is to obviate the above mentioned drawbacks and in particular that of devising a risk assessment method and system for the security of an industrial installation of at least one company able to simplify and speed up the analysis of potential threats.

Another object of the present invention is to provide a risk assessment method and system for the security of an industrial installation of at least one company which allows a systematic assessment of the vulnerabilities of the industrial installation.

These and other objects according to the present invention are achieved by providing a risk assessment method and system for the security of an industrial installation of at least one company as described in the independent claims 1 and 10.

Further features of the risk assessment method and system for the security of an industrial installation of at least one company are the subject of the dependent claims.

The features and the advantages of a risk assessment method and system for the security of an industrial installation of at least one company according to the present invention will appear more clearly from the following description, made by way of a non-limiting example with reference to the annexed schematic drawings, wherein:

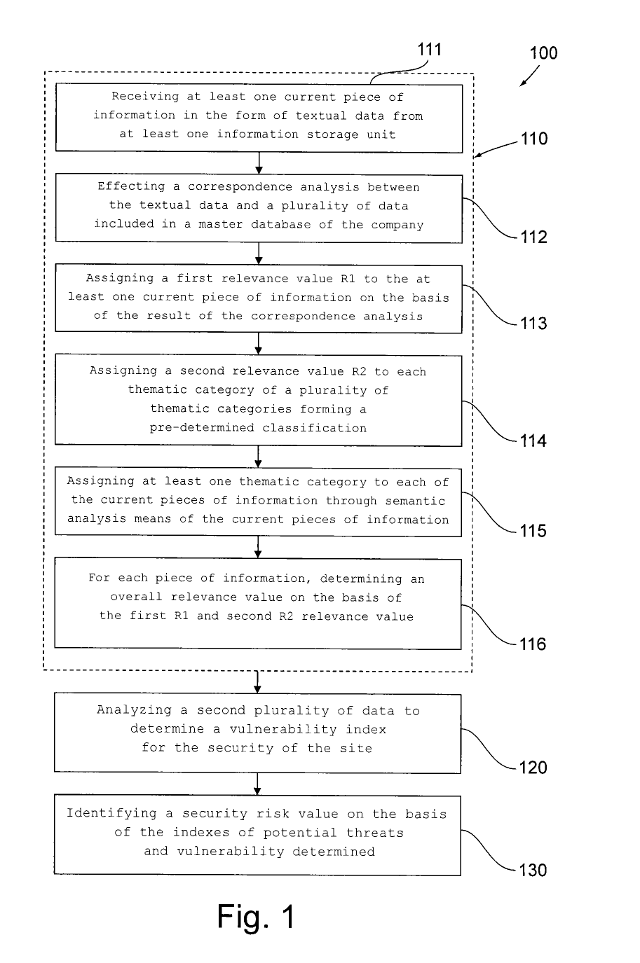

FIG. 1 shows a first flow chart of the phases of the risk assessment method for the security of an industrial installation of at least a company according to the present invention;

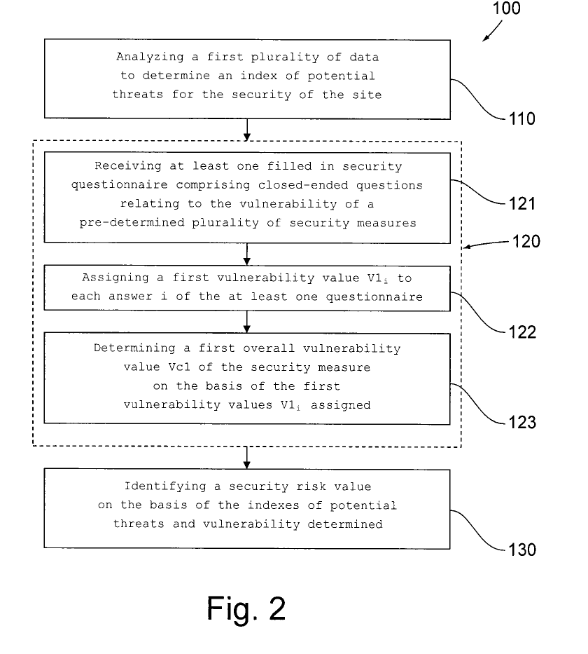

FIG. 2 shows a second flow chart of the phases of the risk assessment method in FIG. 1;

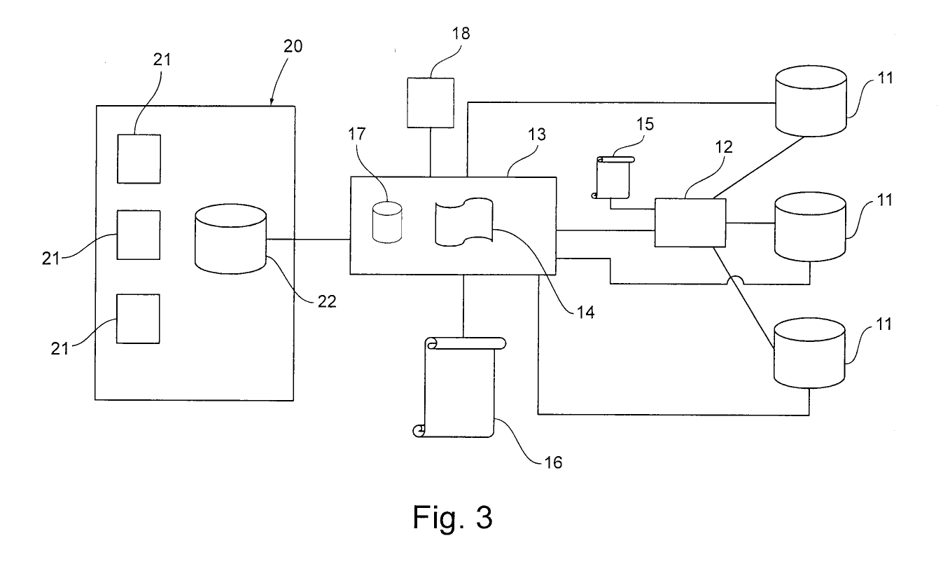

FIG. 3 shows a block diagram showing a risk assessment system for the security of an industrial installation of at least a company according to the present invention.

With reference to the figures, there is shown a risk assessment method for the security of an industrial installation of at least one company, generally indicated with reference numeral 100.

In particular, the at least one company 20 may include one or more industrial installations 21, where by industrial installations it is meant operational manufacturing, commercial or administrative headquarters.

The at least one company 20 further includes at least one master database 22 where the master data of the entities connected to the at least one company are stored, such as names of suppliers, customers, employees or related geographic areas in which they operate, and so on.

The risk assessment method 100 includes the phase which consists in analyzing 100 a first plurality of data to determine an index of potential threats to the security of the industrial installation.

The first plurality of data can be, for example, a collection of information related to current news published on a number of newspapers that are analyzed in order to identify potential threats to the industrial installations 21 of the at least one company 20. The first plurality of data may also include reports or information from non-journalistic sources such as local supervision agencies or employees of the at least one company itself present in the different industrial installations.

The analysis 110 of the first plurality of data determines a risk index that represents the risk of potential threats to the security of the industrial installation.

The risk assessment method 100 also includes the phase which consists in analyzing 100 a second plurality of data to determine a vulnerability index for the security of the industrial installation.

Such a second plurality of data preferably comprises a plurality of questionnaires about the security of industrial installations of the at least one company filled in by a plurality of operators selected from the company staff.

Following the analysis phases 110 and 120, the risk assessment method 100 provides for the phase which consists in identifying 130 a security risk value on the basis of the indexes of potential threats and vulnerabilities determined.

In particular, the analysis phase of the first plurality of data 110 includes the phase that consists in receiving 111 at least one piece of information in the form of textual data from at least one information storage unit 11. Such at least one storage unit 11 preferably is a database of a newspaper in which a plurality of current news published on the newspaper itself is stored.

The at least one storage unit 11 may, alternatively, be a database common to more than one newspaper.

It is noted that the above storage units 11 may belong to newspapers of different states and therefore the textual data can be composed in different languages.

In this case, the analysis phase of the first plurality of data 110 includes the phase that consists in translating the information in a pre-determined reference language, for example through appropriate automatic translation means.

Following the reception phase 111, the analysis phase 110 provides for the operation which consists in effecting 112, through semantic analysis means 12, a correspondence analysis between the textual data and a plurality of data included in the master database 22 of the at least one company.

Such a correspondence analysis 112 is designed to search, among the pieces of information received, those concerning entities related to the company and stored in the master database of the same.

In this way, after the correspondence analysis 112, a first relevance value R1 is assigned 113 to the at least one piece of information on the basis of the result of the correspondence analysis 112 itself.

For example, the first relevance value R1 can be assigned according to the number of occurrences relating to the entities stored in the master database 22, detected in the text of the at least one piece of information.

Alternatively or in addition, a first relevance value R1 may be assigned to each of the entities stored in the master database 22 of company 20. In this case, the first relevance value R1 assigned to an entity is subsequently associated to the information concerning the entity itself.

The first relevance values R1 belong to a pre-determined scale of values, for example a numerical series of values from 1 to 10 wherein the higher the first relevance value R1, the greater the importance of the piece of information to which such a value has been assigned in the security risk assessment.

It is clear that the importance of a piece of information can be related to the pre-determined scale of values according to any correlation law.

Preferably, the analysis phase 110 of the first plurality of data additionally comprises the phase that consists in assigning 114 a second relevance value R2 to each thematic category of a plurality of thematic categories constituting at least one pre-determined classification.

In a particular embodiment of the present invention, the at least one pre-determined classification includes the IPTC (International Press Telecommunications Council) international classification. The thematic categories present in the IPTC International Classification, to which a second relevance value R2 is assigned, are for example called “breach of contract”, “strike”, “standards”, “murder”, and so on.

In a second preferred embodiment of the present invention, the at least one pre-determined classification additionally comprises at least one second classification, such as a proprietary classification defined according to the specific interests of risk analysis of the at least one company and/or a classification whose thematic categories coincide with the sources from which the information to be classified is received.

By way of example, the thematic categories of the proprietary classification are called “Local Risk”, “Global Risk”, “Suppliers”, “Local Institutional Relations”, “Global Institutional Relations” and so on. In such an embodiment, the second relevance value R2 is assigned to each combination of thematic categories, where each element in the combination of thematic categories comes from different classifications.

Similarly to what described above with reference to the first relevance value R1, also the second relevance value R2 belongs to a predetermined scale of values, for example a numerical series of values from 1 to 10, in which the importance of the thematic categories is correlated to the pre-determined scale of values according to any correlation law.

After assigning 114 the second relevance values R2, at least one thematic category or combination of thematic categories is assigned 115 to each piece of information through the semantic analysis means 12 of the pieces of information themselves.

Such semantic analysis means 12 preferably are known computer programs capable of executing a semantic analysis of a text in order to identify the subject dealt with, such as for example the program called COGITO®.

The result of the semantic analysis carried out therefore allows the thematic categories or combinations of thematic categories to be assigned to the single pieces of information according to the subject dealt with.

For each piece of information, thereafter, an overall relevance value Rc is determined 116 on the basis of the first R1 and second R2 relevance value.

In particular, the overall relevance value Rc is determined on the basis of the first and second relevance value.

Preferably, the analysis phase 110 of the first plurality of data additionally comprises the phase (not shown) which consists in assigning a reliability value AT to each information storage unit.

In this way, each source contributing to sending the information is indexed on the basis of the reliability of its information.

In this case, after assigning the reliability value AT, the overall relevance value Rc of a current piece of information is modified on the basis of the reliability value AT assigned to the at least one storage unit from which the piece of information itself comes.

Preferably, the risk assessment method 100 additionally comprises the phase (not shown) of identifying a plurality of pieces of information relating to a same event by means of the semantic analysis means into a set of information received in a pre-determined time interval, for example twenty-four hours.

In this case, the plurality of identified information relating to a same event is collected in an information group and such an information group is assigned a group relevance value Rg according to the number of the plurality of information constituting the group.

In this way, the operator in charge of analyzing the plurality of pieces of information does not have to read multiple pieces of information about current news relating to a same event, thus saving time.

In a preferred embodiment of the present invention, the analysis phase 120 of the second plurality of data comprises the phase which consists in receiving 121 at least one filled in security questionnaire comprising closed-ended questions regarding the vulnerability of a plurality of pre-determined security measures. The at least one questionnaire is preferably filled in by at least one operator in such a way as to have an answer to each question included in said questionnaire.

It is noted that each questionnaire received is related to a single security measure adopted at an industrial installation, for example a fence, an external alarm system, and so on.

In this case, a first vulnerability value V1ᵢ is assigned 122 to each i-th answer of the at least one questionnaire and a first overall vulnerability value Vc1 of the security measure is determined 123 on the basis of the first vulnerability values V1ᵢ assigned.

For example, the vulnerability values V1ᵢ may belong to a pre-determined scale of values, such as for example a numerical series from 1 to 4.

Advantageously, the determination phase 123 of the first overall vulnerability value Vc1 comprises the phase that consists in assigning a weighing coefficient Cpᵢ to each i-th question of the at least one questionnaire.

In this case, the first overall vulnerability value Vc1 is determined as a result of an equation of the following form:

$$Vc 1 = {\sum }_{i = 1}^{n} \frac{( {Cp}_{i} * V {1}_{i} )}{{\sum }_{i = 1}^{n} ( {Cp}_{i} )}$$

wherein n represents the number of i-th questions contained the at least one questionnaire.

Preferably, the analysis phase of the second plurality of data additionally comprises the phase that consists in selecting a plurality of key-questions among the questions contained in the at least one questionnaire.

Such key-questions, in particular, relate to more general security aspects, the assessment of which may be needed to verify compliance with a plurality of laws on security.

In this case, a second overall vulnerability value Vc2 of the industrial installation is determined as a result of an equation of the following form:

$$Vc 2 = {\sum }_{i = 1}^{p} \frac{( {Cp}_{i} * V {1}_{i} )}{{\sum }_{i = 1}^{p} ( {Cp}_{i} )}$$

wherein p represents the number of key-questions contained the at least one questionnaire.

In a preferred embodiment of the present invention, the phase of identifying 130 the security risk value Vr comprises the phase which consists in determining such a risk value Vr on the basis of the first plurality of data analyzed and of the second overall vulnerability value.

According to the present invention, the risk assessment method 100 is automatically executed by an electronic system 10.

Such an electronic system 10 comprises at least one information storage unit 11, one processing unit 13 arranged to receive at least one piece of information in the form of textual data from the at least one information storage unit 11 and semantic analysis means 12 associated to the at least one storage unit 11 and to the processing unit 13.

The semantic analysis means 12 are, in particular, configured to assign at least one thematic category belonging to a pre-determined classification to each piece of information and provide a list of classified pieces of information 15.

Advantageously, the processing unit 13 is connected to the master database 22 of company 20 and includes software means 14 configured to implement the risk assessment method described above.

In particular, such software means 14 are a computer program loadable into the memory of the electronic processing unit 13 itself and comprising portions of software code for implementing the phases of the method according to the present invention.

In detail, such software means 14 are configured to carry out, through the semantic analysis means 12, the correspondence analysis between the textual data and the plurality of data included in the master database of company 20 and to assign the first relevance value R1 to the at least one current piece of information according to the result of the correspondence analysis itself as described above.

The software means 14 are also configured to assign the second relevance value R2 to each thematic category of the pre-determined classification and store each category with the corresponding second relevance value R2 to an internal database 17 included in the processing unit 13. Following the semantic analysis, the processing unit 13 is then able to associate a second relevance value R2 to each current piece of information according to the thematic categories to which the piece of information belongs.

The software means 14 are configured to determine, for each piece of information, an overall relevance value Rc on the basis of the first relevance value assigned R1 and of the second R2 relevance value.

Preferably, the software means 14 can be configured to assign a reliability value AT to each information storage unit 11 and store such reliability values AT to the internal database 17.

In this case, the software means 14 modify the overall relevance value Rc of a piece of information on the basis of the reliability value AT assigned to the at least one storage unit from which the piece of information itself comes.

Preferably, the software means 14 are also configured to collect a plurality of pieces of information relating to current news related to a same event received in a pre-determined time interval in an information group, then assigning the group relevance value Rg to each group according to the number of the plurality of pieces of information constituting the group.

In this case, the software means 14 also comprise a graphical interface in which the list of information groups is shown, where each group is depicted with different colors or different font size depending on the group relevance value Rg and therefore, on the number of pieces of information constituting the group itself.

Moreover, thanks to the aforementioned graphical interface, such an operator can give priority to the analysis of larger and more relevant information groups.

Advantageously, the electronic system 10 includes data acquisition means 18, for example a scanner, connected to the processing unit 13. Such data acquisition means are able to acquire the at least one filled in security questionnaire comprising closed-ended questions regarding the vulnerability of a plurality of pre-determined security measures.

In addition or alternatively to the data acquisition means, the electronic system 10 may be configured to enable the filling in of the at least one questionnaire directly in electronic format.

Once acquired or filled in in electronic format, the at least one security questionnaire is sent to the processing unit 13, where the software means 14 assign a first vulnerability value V1ᵢ to each i-th answer of the at least one questionnaire and determine a first overall vulnerability value Vc1 of the security measure according to the first vulnerability values V1ᵢ assigned.

In particular, the software means 14 are able to determine the first overall vulnerability value solving the equation of the following form:

$$Vc 1 = {\sum }_{i = 1}^{n} \frac{( {Cp}_{i} * V {1}_{i} )}{{\sum }_{i = 1}^{n} ( {Cp}_{i} )}$$

where n indicates the number of i-th questions contained in the at least one questionnaire and Cpi indicates the weighing coefficient assigned to each i-th question of the at least one questionnaire.

Preferably, the software means 14 are configured to select a plurality of key-questions among the questions contained in the at least one questionnaire, and to determine a second overall vulnerability value Vc2 of the industrial installation, as a result of an equation of the following form:

$$Vc 2 = {\sum }_{i = 1}^{p} \frac{( {Cp}_{i} * V {1}_{i} )}{{\sum }_{i = 1}^{p} ( {Cp}_{i} )}$$

wherein p represents the number of key-questions contained the at least one questionnaire.

Advantageously, the software means 14 may also be configured to determine the risk value Vr as a function of the first plurality of data analyzed and the second overall vulnerability value.

Preferably, the software means 14 are configured to translate the information into a pre-determined reference language, including for example automatic translation programs.

The features of the risk assessment method and system for the security of an industrial installation of at least one company, object of the present invention, as well as its advantages, are clear from the above description.

In fact, the risk assessment method and system according to the present invention allow not only the pieces of information to be classified by subject matter, but also the pieces of information to be sorted according to their relevance. This simplifies the analysis of information for the identification of potential threats to security, also making it more reliable and quicker.

The early detection of threats is necessary to intervene in a timely and effective manner on the vulnerabilities of the industrial installation in order to ensure a low security risk.

The cataloging of pieces of information according to a pre-determined classification, and in particular an international classification such as the IPTC, also makes the method of the present invention systematic and applicable to any type of industrial installation.

Finally, it is clear that several changes and variations may be made to the risk assessment method and system for the security of an industrial installation of at least one company thus conceived, all falling within the invention; moreover, all details can be replaced with technically equivalent elements. In the practice, the materials used as well as the sizes, can be whatever, according to the technical requirements.

1. A risk assessment method for the security of an industrial installation of at least one company, comprising:
analyzing a first plurality of data in order to determine a potential threat index for the security of said industrial installation;
analyzing a second plurality of data to determine a vulnerability index for the security of said industrial installation;
identifying a security risk value on the basis of said potential threat and vulnerability indexes determined;
wherein said analyzing of said first plurality of data comprises the:
receiving at least one piece of information in the form of textual data from at least one information storage unit;
effecting a correspondence analysis between said textual data and a plurality of data included in a master database of said at least one company;
assigning a first relevance value (R1) to said at least one piece of information according to the result of said correspondence analysis.

2. The risk assessment method according to claim 1, wherein said analyzing of said first plurality of data additionally comprises:
assigning a second relevance value (R2) to each thematic category of a plurality of thematic categories, forming at least one predetermined classification;
assigning at least one thematic category to each of the pieces of information through semantic analysis means of said information;
determining for each piece of information, an overall relevance value (Rc) on the basis of said first (R1) and second (R2) relevance values.

3. The risk assessment method according to claim 2, wherein said at least one pre-determined classification is the IPTC (International Press Telecommunication Council) international classification.

4. The risk assessment method according to claim 2, wherein said at least one classification comprises at least two classifications and said second relevance value (R2) is assigned to a combination of thematic categories, each element of said combination of thematic categories coming from different classifications of said at least two classifications.

5. The risk assessment method according to claim 1, wherein said analyzing of said first plurality of data, additionally comprises:
assigning a reliability value (AT) to each information storage unit;
modifying said overall relevance value (Rc) according to said reliability value (AT) assigned to at least one storage unit from which said at least one piece of information derives.

6. The risk assessment method according to claim 1, additionally comprising the phases:
identifying a plurality of pieces of information relating to current news concerning the same event through said semantic analysis means (12) in a group of information pieces received within a predetermined time interval;
collecting said plurality of pieces of information identified to form an information group;
assigning a group relevance value (Rg) to said information group according to the number of said plurality of pieces of information forming said group.

7. The risk assessment method according to claim 1, wherein the analyzing of said second plurality of data comprises:
receiving at least one security questionnaire comprising closed-ended questions relating to the vulnerability of a plurality of predetermined security measures, said at least one questionnaire being filled in by at least one operator so as to have an answer to each question included in said at least one questionnaire;
assigning a first vulnerability value Vli to each i-th answer of said at least one questionnaire;
determining a first overall vulnerability value Vc1 of the security measure according to said first vulnerability values Vli assigned.

8. The risk assessment method according to claim 7, wherein the determining of said first overall vulnerability value Vc1 comprises:
assigning a weighting coefficient Cpi to each question i of said at least one questionnaire;
determining said first overall vulnerability value Vc1 as a result of an equation of the following form:
Vc1=Σᵢ₌₁ⁿ(Cpᵢ*V1ᵢ)/Σᵢ₌₁ⁿ(Cpᵢ)
wherein n represents the number of questions contained in said at least one questionnaire.

9. The risk assessment method according to claim 8, wherein the analyzing of said second plurality of data additionally comprises:
selecting a plurality of key-questions among the questions contained in said at least one questionnaire;
determining a second overall vulnerability value of said industrial installation Vc2 as the result of an equation of the following form:
Vc2=Σᵢ₌₁^{p}(Cpᵢ*V1ᵢ)/Σᵢ₌₁^{p}(Cpᵢ)
wherein p represents the number of key-questions contained in said at least one questionnaire.

10. An electronic system for risk assessment for the security of an industrial installation of at least one company, wherein said at least one company comprises at least one master database, said electronic system comprising:
at least one information storage unit;
a processing unit suitable for receiving at least one piece of information in the form of textual data from said at least one information storage unit;
semantic analysis means associated with said at least one storage unit and said processing unit,
wherein said processing unit is connected to said master database of at least one company and comprises software means configured for implementing the risk assessment method according to claim 1.

11. A processing program that can be loaded into the memory of an electronic processing unit and comprising portions of software codex for implementing steps of the method according to claim 1.
